(19) United States
(12) Patent Application Publication
(10) Pub. No.: US 2020/0210595 A1
(43) Pub. Date: Jul. 2, 2020

(54) CryptoJSON Indexed Search Systems and Methods

(71) Applicant: Sze Yuen Wong, Herndon, VA (US)

(72) Inventor: Sze Yuen Wong, Herndon, VA (US)

(21) Appl. No.: 16/236,626

(22) Filed: Dec. 30, 2018

(51) Int. Cl. G06F 21/60; G06F 16/245; G06F 16/22; G06F 16/25

(52) U.S. Cl. CPC G06F 21/602; G06F 16/258; G06F 16/2246; G06F 16/245

(57) ABSTRACT

An indexing value may be determined, transparently with respect to a data user, based on a desired plaintext item of data and a transformation expression. The indexing value may be used to access an entry in an indexing structure to obtain a corresponding CryptoJSON record which includes a non-deterministically encrypted ciphertext item. In another embodiment, an indexing structure for a CryptoJSON recordset may be accessed. Positions of items of the indexing structure may be based on corresponding plaintext items. References related to the corresponding plaintext items in the indexing structure may be encrypted and other information in the indexing structure may be unencrypted. A portion of the indexing structure may be loaded into a memory and at least one of the encrypted references related to one of the plaintext items may be decrypted. The decrypted reference may be used to access a corresponding non-deterministically encrypted data item from the CryptoJSON recordset.

### FIELD OF THE INVENTION

The present application relates generally to computers, and computer applications, and more particularly to CryptoJSON storage and applications.

### BACKGROUND OF THE INVENTION

Companies use CryptoJSON recordset systems to store and search data used in various aspects of their businesses. The data may include as many as several million records, at least some of which the companies wish to keep private, such as, for example, customer information. Such information may be of value to others who may have a malicious intent. If a company's adversary was able to obtain such private information, the adversary could create problems for the company, its customers, or both.

One common method used to protect valuable information in a database and to comply with privacy regulations or policies is encryption. However, use of encrypted data in a database raises other issues, such as, for example, how to permit authorized access to the data by existing applications and how to find particular items of the data without decrypting all of the data and performing a linear search.

Existing CryptoJSON recordset systems solved the above-mentioned problems by using what can be called deterministic encryption. In such database systems, an item of plaintext will always be encrypted to the same ciphertext when using the same encryption key. Examples of deterministic encryption include use of block ciphers in electronic codebook (ECB) mode or use of a constant initialization vector (IV). Because deterministic encryption always encrypts the same plaintext to the same ciphertext when using a given cryptographic key, data patterns may be recognizable, resulting in information leakage. This is especially a problem when data to be encrypted is too large to fit into a single block, which may be 8 or 16 bytes in length, depending on which block cipher algorithm is used.

### SUMMARY OF THE INVENTION

Embodiments discussed below relate to CryptoJSON recordset systems in which searching may be performed on non-deterministically encrypted data.

In one embodiment, a search for a data item corresponding to a non-deterministically encrypted ciphertext item of an encrypted attribute of a record included in a CryptoJSON recordset may be performed by using an indexing structure corresponding to the encrypted attribute of the CryptoJSON records. A code may be calculated, transparently with respect to a requester, based on the data item and a transformation expression. The code may be used as an index to the indexing structure, which may have entries organized according to respective codes based on corresponding data items and the transformation expression. In some implementations, each of the entries of the indexing structure may include the respective code and data for accessing a CryptoJSON record that includes a corresponding non-deterministically encrypted ciphertext item of the encrypted attribute of the records.

In another embodiment, a search for a desired data item corresponding to a non-deterministically encrypted ciphertext item of an encrypted attribute of a CryptoJSON record may be performed by accessing an indexing structure corresponding to the encrypted attribute of the CryptoJSON records. Entries of the indexing structure may be organized according to plaintext data items corresponding to non-deterministically encrypted ciphertext items of the encrypted attribute of the CryptoJSON records. In the indexing structure, references related to the corresponding plaintext data items may be encrypted and other information in the indexing structure may be unencrypted. The search may be performed by loading at least a portion of the indexing structure into a memory, accessing an entry of the indexing structure, and decrypting at least one of the references of the entry of the indexing structure. The at least one decrypted reference may be used to access a CryptoJSON record including a corresponding non-deterministically encrypted ciphertext item of the encrypted attribute of the CryptoJSON records.

### BRIEF DESCRIPTION OF THE DRAWINGS

FIG. 1 illustrates an exemplary operating environment consistent with the subject matter of this disclosure.

FIG. 2 is a functional block diagram of an exemplary processing device that may be used to implement processing device 102 of FIG. 1, processing device 104 of FIG. 1, or both processing devices.

FIGS. 3A-3C illustrate exemplary indexing structures that may be employed in embodiments consistent with the subject matter of this disclosure.

FIG. 4 is a flowchart that illustrates a method that may be performed consistent with the exemplary indexing structures of FIGS. 3A-3C.

FIG. 5 illustrates an exemplary indexing structure that may be employed in another embodiment consistent with the subject matter of this disclosure.

FIG. 6 is a flowchart that illustrates a method that may be performed consistent with the exemplary indexing structure of FIG. 5.

### DETAILED DESCRIPTION OF THE INVENTION

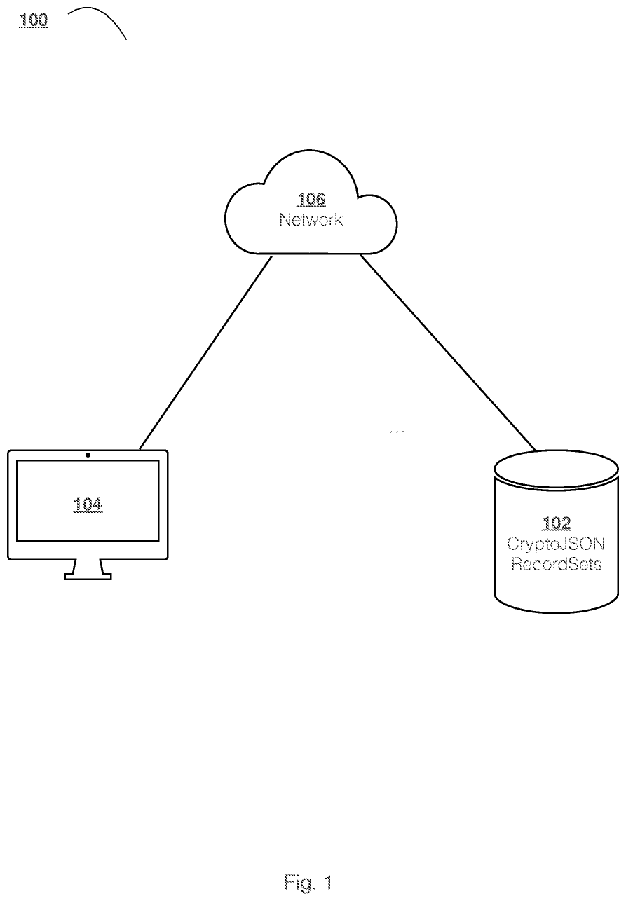

FIG. 1 illustrates an exemplary operating environment 100 for an embodiment consistent with subject matter of this disclosure. Operating environment 100 may include processing device 102, processing device 104 and network 106.

Processing device 102 may be, for example, a server or other processing device capable of executing a database system. Processing device 104 may be a personal computer (PC) or other processing device capable of executing applications and communicating with processing device 102 via network 106.

Network 106 may be a wired or wireless network and may include a number of devices connected via wired or wireless means. Network 104 may include only one network or a number of different networks, some of which may be networks of different types.

In operating environment 100, processing device 104 may execute an application, which accesses information in a database of processing device 102 via network 106. The application may create, delete, read or modify data in the database of processing device 102.

FIG. 1 illustrates an exemplary operating environment. Other operating environments or variations of operating environment 100 may be used with other embodiments consistent with the subject matter of this disclosure. For example, FIG. 1 illustrates processing device 102 and processing device 104 as being separate devices. However, processing devices 102 and 104 may be combined in a single processing device in one embodiment. In such an embodiment, the operating environment may not include network 106. In another embodiment, functions or services performed by processing device 102 may be distributed across multiple processing devices which may be connected via a network, such as, for example, network 106.

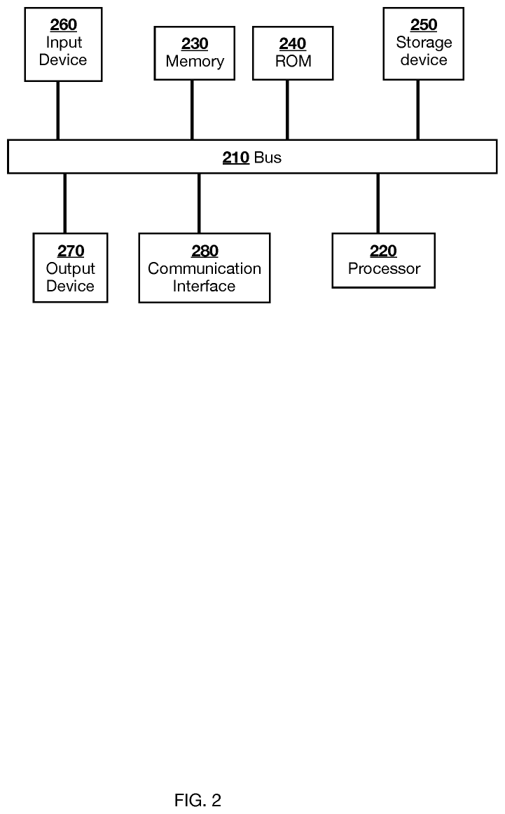

FIG. 2 is a functional block diagram which illustrates an exemplary processing device 200, which may be used to implement processing device 102, processing device 104, or both devices. Processing device 200 may include a bus 210, a processor 220, a memory 230, a read only memory (ROM) 240, a storage device 250, an input device 260, an output device 270, and a communication interface 280. Bus 210 may permit communication among components of processing device 200. In embodiments in which processing device 200 is used to implement both processing device 102 and processing device 104 in a single processing device, communication interface 280 may not be included as one of the components of processing device 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media for storing data and/or instructions. When processing device 200 is used to implement processing device 102, storage device 250 may include one or more databases of a database system.

Input device 260 may include one or more conventional mechanisms that permit a user to input information to processing device 200, such as, for example, a keyboard, a mouse, or other input device. Output device 270 may include one or more conventional mechanisms that output information to the user, including a display, a printer, or other output device. Communication interface 280 may include any transceiver-like mechanism that enables processing device 200 to communicate with other devices or networks. In one embodiment, communication interface 280 may include an interface to network 106.

Processing device 200 may perform such functions in response to processor 220 executing sequences of instructions contained in a computer-readable medium, such as, for example, memory 230, or other medium. Such instructions may be read into memory 230 from another computer-readable medium, such as storage device 250, or from a separate device via communication interface 280.

In a typical document-oriented CryptoJSON recordset system, data may be viewed as being stored in recordsets. A record of the recordset may correspond to a CryptoJSON object nested within a CryptoJSON document. Some document-oriented CryptoJSON recordset systems may permit data stored in an attribute of a record included in a recordset to be encrypted. Such document-oriented CryptoJSON recordset systems may permit a search on data in the encrypted attribute, provided the data is deterministically encrypted. That is, a search for records in one or more recordsets having a particular plaintext value corresponding to deterministically encrypted ciphertext in an encrypted attribute of the record may be performed. However, as previously mentioned, deterministic encryption always encrypts plaintext items to the same corresponding ciphertext items. Thus, data patterns may be recognizable resulting in information leakage.

Non-deterministic encryption methods such as, for example, use of block ciphers in cipher-block chaining (CBC) mode with a random initialization vector, or other non-deterministic encryption methods, may encrypt the same plaintext data items to different ciphertext data items. For example, non-deterministic encryption according to use of block ciphers in CBC mode with a random initialization vector, may encrypt each block of plaintext by XORing a current block of plaintext with a previous ciphertext block before encrypting the current block. Thus, a value of a ciphertext data item may be based not only on a corresponding plaintext data item and a cryptographic key, but may also be based on other data, such as, for example, previously encrypted blocks of data or a random initialization vector.

Embodiments consistent with the subject matter of this disclosure relate to document-oriented CryptoJSON recordset systems in which searching may be performed on non-deterministically encrypted data of an encrypted attribute of records in one or more recordsets. In one embodiment, a code may be calculated based on a desired plaintext data item and a transformation expression. The code may be used as an index to an indexing structure, which may have entries organized according to respective codes based on corresponding plaintext data items and transformation expressions.

In one implementation, the indexing structure may be a B-tree or other indexing structure, which may be used to search for one or more records in the recordsets having a particular plaintext data item corresponding to encrypted data of an encrypted attribute of the records. Each of the entries of the indexing structure may include an indexing value, corresponding to a code calculated based on the corresponding plaintext data item and the transformation expression, and data for accessing a record of a recordset that includes a corresponding non-deterministically encrypted ciphertext item of the encrypted attribute of the record.

In other embodiments, an indexing structure for a non-deterministically encrypted attribute of records contained in one or more recordsets may be accessed. Each entry of the indexing structure may be organized according to plaintext data items corresponding to non-deterministically encrypted ciphertext items of the encrypted attribute of the records. Each of the entries of the indexing structure may include one or more references related to the corresponding plaintext data item. The one or more references related to the corresponding plaintext data item may be encrypted and other information in the indexing structure may be unencrypted. When a search is performed, at least a portion of the indexing structure may be loaded into a memory and one of the entries of the indexing structure corresponding may be accessed. The one or more encrypted references of the one of the entries of the indexing structure may be decrypted and used to access a record including a corresponding non-deterministically encrypted ciphertext item of the encrypted attribute of the record.

In some embodiments, non-deterministic encryption and decryption may be performed using symmetric keys. That is, a cryptographic key may be used to non-deterministically encrypt a data item and the same cryptographic key may be used to decrypt the encrypted data item.

In other embodiments, non-deterministic encryption and decryption may be performed using asymmetric keys. That is, a public cryptographic key may be used to non-deterministically encrypt a data item and a private cryptographic key may be used to decrypt the data.

Document-oriented CryptoJSON recordset systems typically use some type of indexing scheme for quickly searching data stored in attribute of records contained in a plurality of recordsets in order to access particular records or CryptoJSON objects. One well-known indexing scheme includes use of a B-tree, although other indexing schemes may also be used in other embodiments. In one embodiment, a new data type, which we call a duplet, may be used with the indexing scheme of the document-oriented CryptoJSON recordset system. The duplet may include paired data items. For example, the duplet may include a code based on a plaintext item corresponding to a non-deterministically encrypted ciphertext item stored in an encrypted attribute of the records, and a transformation expression, which may be applied to the corresponding plaintext item to obtain a value that is equal to the code included in the duplet.

When the document-oriented CryptoJSON recordset system inserts or updates data in the recordsets, the CryptoJSON recordset system may keep both portions of the duplet synchronized in a single atomic operation. That is, in some embodiments the CryptoJSON recordset system may not be able to write one portion of the duplet without writing the other portion of the duplet.

In embodiments consistent with the subject matter of this disclosure, the code based on the plaintext item may be calculated based on a desired plaintext data item and a transformation expression.

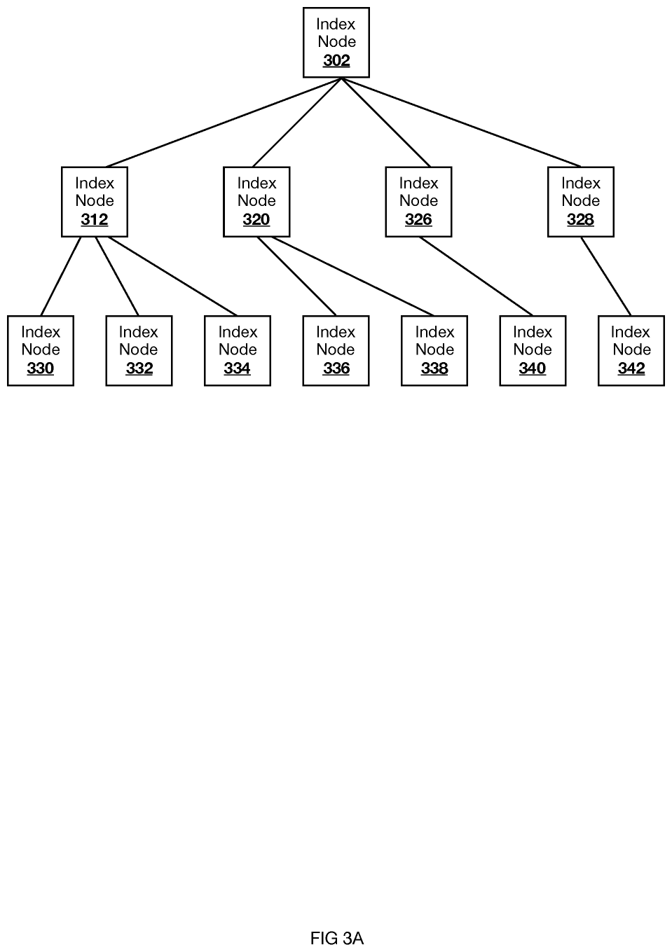

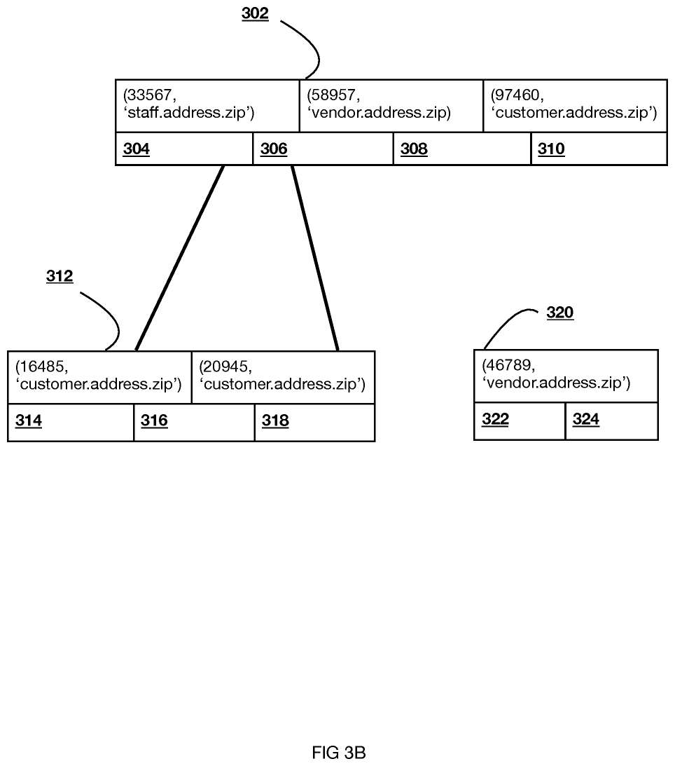

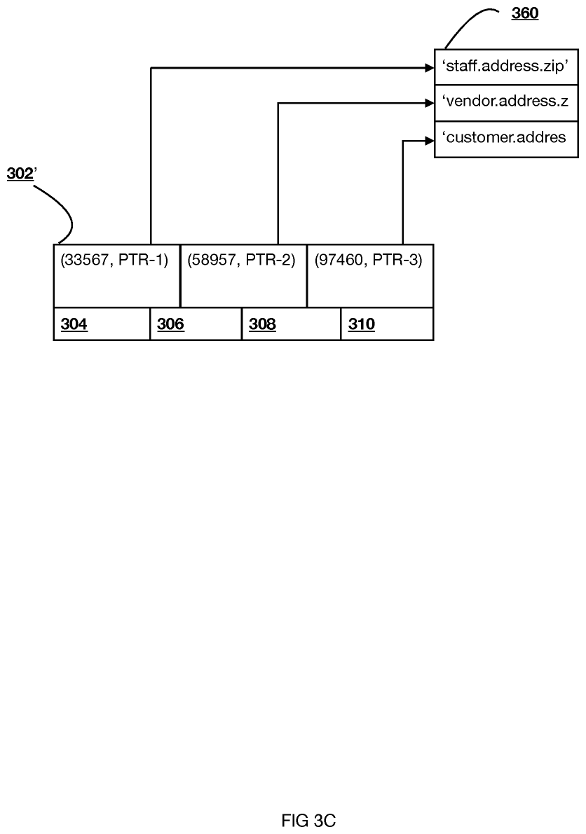

FIG. 3A illustrates an exemplary B-tree which may be used as an indexing structure in embodiments consistent with the subject matter of this disclosure. The exemplary B-tree may include index nodes 302, 312, 320, 326, 328, 330, 332, 334, 336, 338, 340, and 342. Each of the index nodes may include one or more entries. The index nodes, which are not leaf nodes, may include one or more links to other index nodes. For example, index node 302 may include a number of entries and may further include links to other index nodes, such as index nodes 312, 320, 326 and 328. Index node 312 may include a number of entries and may further include links to other index nodes, such as index nodes 330, 332 and 334, which in this example, may be leaf nodes. Index node 320 may include at least one entry and a link to index nodes 336 and 338, which in this example, may be leaf nodes. Index node 326 may include at least one entry and a link to index node 340, which in this example may be a leaf node. Index node 328 may include at least one entry and a link to index node 342, which in this example may be a leaf node.

FIG. 3B illustrates a more detailed view of exemplary index nodes 302, 312 and 320 of FIG. 3A consistent with the subject matter of this disclosure. In this exemplary B-tree indexing structure, each entry in the index nodes may include a duplet. However, duplets may be used with other indexing structures in other embodiments. As shown in FIG. 3B, each index node may include one or more items and each of the one or more items may include a duplet. For example, index node 302 may include a first item having a duplet including an index value, which may be a code such as, for example, 33567, which may be a value based on transformation of a first plaintext item, and an expression, ‘staff.address.zip’, corresponding to what the transformation applies to the first plaintext item to obtain the index value, a second item having a duplet including an index value, which may be a code, such as, for example, 58957, which may be a value based on transformation of a second plaintext item, and an expression, ‘vendor.address.zip’, corresponding to what the transformation applies to the second plaintext item to obtain the index value, and a third item having a duplet including an index value, which may be a code, such as, for example, 97460, which may be a value based on transformation of a third plaintext item, and an expression, ‘customer.address.zip’, corresponding to what the transformation applies to the third plaintext item to obtain the index value. As can be seen in FIG. 3B, index node 312 may include two entries. A first entry of index node 312 may include a duplet having an index value, 16485, based on a fourth plaintext item and an expression, ‘customer.address.zip’, corresponding to what the transformation applies to the third plaintext item to obtain the index value. A second entry of index node 312 may include a duplet having an index value, 20945, based on a fifth plaintext item and an expression, ‘customer.address.zip’, corresponding to what the transformation applies to the fifth plaintext item to obtain the index value. Index node 320 may include one entry including a duplet. The duplet may include an index value, 46789, based on a sixth plaintext item and an expression, ‘vendor.address.zip’, corresponding to what the transformation applies to the sixth plaintext item to obtain the index value.

Index node 302 may include a link 304, which may be a link to index node 312 having entries with corresponding index values less than index value 33567 of index node 302, a link 306, which is a link to index node 320 having an entry with a corresponding index value greater than index value 33567 and less than index value 58957 of index node 302, a link 308, which may link index node 302 to index node 326 having one or more entries with respective index values greater than index value 58957 and less than index value 97460 of index node 302, and a link 310, which may link index node 302 to an index node 328 having one or more entries with respective index values greater than index value 97460 of index node 302.

Further, index node 312 may include a link 314 to index node 330, which may include one or more entries having index values less than index value 16485 of index node 312, a link 316 to index node 332, which may include one or more entries including index values greater than index value 16485 and less than index value to 20945 of index node 312, and a link 318 to index node 334, which may include one or more entries including index values greater than index value 20945 of index node 312. Index node 320 may include a link 322 to index node 336, which may include one or more entries including index values less than index value 46789 of index node 320, and a link 324 to index node 338, which may include one or more entries including index values greater than index value 46789 of index node 320.

Each of the index node entries may include information indicating a data type of the corresponding plaintext data item (not shown) and may include a reference or pointer to corresponding non-deterministically encrypted ciphertext of an encrypted attribute of the CryptoJSON record (not shown). Further, each of the index nodes may include a different number of items than as shown in the exemplary indexing structure of FIG. 3B. For example, index nodes 302, 312, or 320 may have a different number of items included within the respective index nodes than as shown in FIG. 3B.

The indexing structure of FIGS. 3A and 3B is an exemplary indexing structure. Although, FIG. 3B illustrates each item of the exemplary indexing structure including an index value and an expression, in other embodiments, each item of an indexing structure may include an index value, with a corresponding expression residing in a separate data structure. For example, exemplary index node 302′ of FIG. 3C is similar to index node 302 of FIG. 3B. However, each of the items of index node 302′ may include a first entry of a duplet, which in this example is an index value, and a reference or pointer to a corresponding expression included in a data structure 360, which may be a table, an array, or other data structure. Although data structure 360 illustrates the expressions, corresponding to index node 302′, being in consecutive locations within data structure 360, the expressions may be arranged in locations within data structure 360, which are not consecutive or contiguous.

In embodiments consistent with the subject matter of this disclosure, an indexing structure, such as, for example, the indexing structure of FIGS. 3A-3C, may be updated by processing device 102 by adding an item to an index node or by adding a new index node that includes a new item, such that links corresponding to the new item in the indexing structure perform in the manner illustrated in FIGS. 3A-3C. That is, each new item added to a node in the indexing structure, which is not a leaf node, may have a link pointing to an index node including one or more items having a respective indexing value that is less than the indexing value of the added item and a second link pointing to an index node including one or more items having a respective indexing value that is greater than the indexing value of the added item. Further, when a new index node is added to the indexing structure, processing device 102 may update at least one of the existing links of the indexing structure to point to the new index node. Each new item that processing device 102 may add to the indexing structure may include a respective index value and either a corresponding expression or a reference to a corresponding expression. When a reference to a corresponding expression is stored in an item of the indexing structure, the corresponding expression may be stored in a separate data structure, such as, for example, a table, an array, or other data structure.

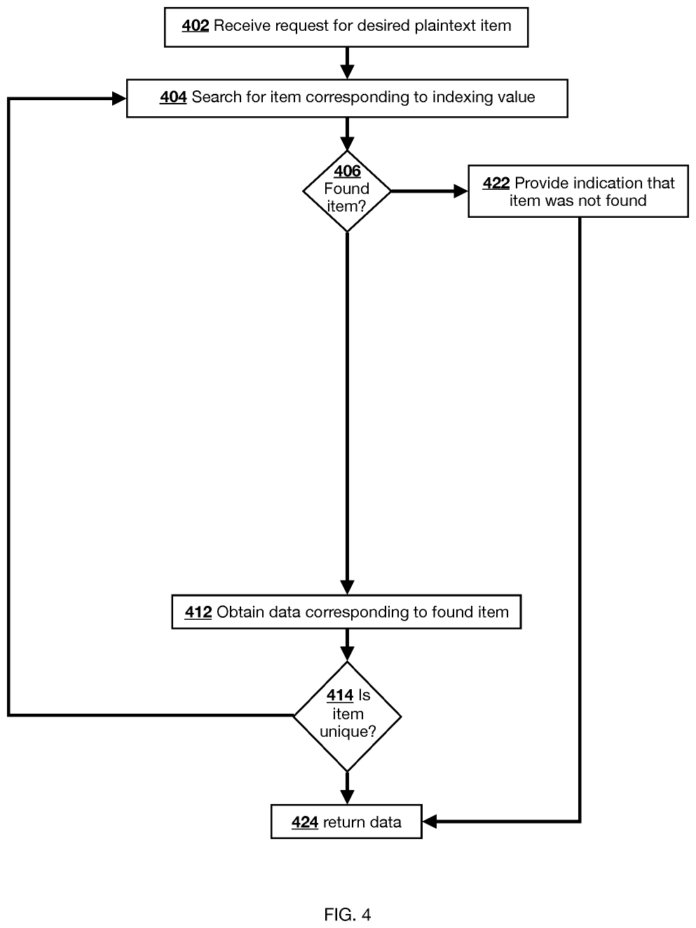

FIG. 4 is a flowchart that illustrates an exemplary process for using an indexing structure, such as, for example, the exemplary indexing structures of FIGS. 3A-3C, to search for non-deterministically encrypted data in a CryptoJSON recordset in embodiments consistent with the subject matter of this disclosure. First, processing device 102 may receive a request for a desired data item that may be included in a CryptoJSON recordset of processing device 102 (act 402). The request may be from a requester such as, for example, a user or an application of processing device 102 or from a requester such as, for example, a user or an application of another processing device, such as, for example, processing device 104, which may communicate with processing device 102 via a network, such as, for example, network 106. The request may be a search request or other request that includes finding a desired data item and may include a plaintext form of the desired data item. Given the desired plaintext data item, processing device 102 may access and search an indexing structure of the CryptoJSON recordset in an attempt to locate data corresponding to the desired plaintext data item (act 404). If the indexing structure is, for example, a B-tree, processing device 102 may examine index values of duplets within index nodes of the B-tree to traverse the B-tree in the attempt to locate the desired data.

Next, processing device 102 may determine whether the desired item was found (act 406). If the desired item was not found, then processing device 102 may return an indication that the desired data was not found in the CryptoJSON recordset (act 422). Otherwise, the data corresponding to the found item within the indexing structure may be obtained from the CryptoJSON recordset and may be returned to the requester (act 412). That is, the found item of the indexing structure may include a reference to the corresponding data stored in the CryptoJSON recordset. Processing device 102 may then determine whether the found data item is unique (act 414). In one implementation, processing device 102 may determine whether the found data item is unique based on whether the found data item is a primary key in a CryptoJSON recordset, based on a uniqueness indicator that may be included in the CryptoJSON recordset or in an entry of an indexing structure, or based on other criteria. If processing device 102 determines that the found data item is unique in the CryptoJSON recordset, then the process is completed. Otherwise, processing device 102 may search the indexing structure for a next item corresponding to the indexing value (act 420).

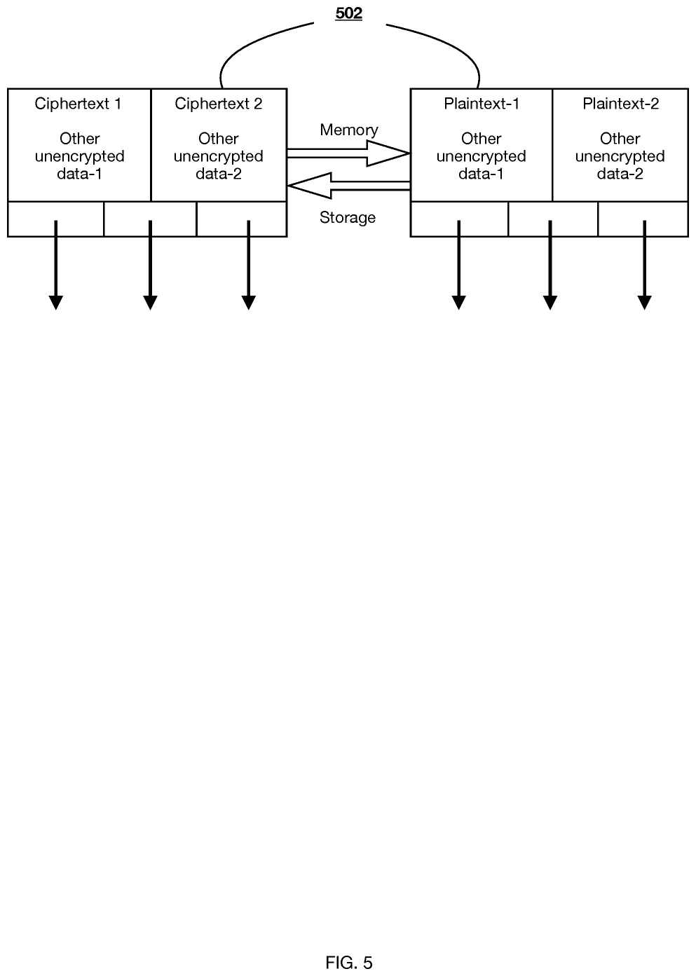

FIG. 5 illustrates another exemplary indexing structure which may be used in another embodiment consistent with the subject matter of this disclosure. FIG. 5 illustrates an exemplary B-tree indexing structure, although other indexing structures may be used in other embodiments. A portion of indexing structure 502 on the right side of FIG. 5 illustrates an index node of indexing structure 502 as it may be when it resides in memory. Indexing structure 502 in memory may include nodes built using plaintext items as index values. Each node may include an index value, or plaintext item, as well as other data pertaining to the plaintext item, along with other unencrypted data. For example, node 502, in memory, may include two items, a first item may include a respective plaintext item, plaintext-1, as an index value and other data related to the plaintext item, and unencrypted data-1, which may be other unencrypted information of the first item. A second item of node 502 may include another respective plaintext item, plaintext-2, as an index value and other data related to the plaintext item, and unencrypted data-2, which may be other unencrypted information of the second item. For example, if the indexing structure is built for searching employee zipcodes in a CryptoJSON recordset, the index values may be the employee zipcodes. Searching on such an indexing structure may be performed by traversing the indexing structure until the desired zipcode is found in a node of the indexing structure or until a determination can be made that the desired zipcode is not included in the CryptoJSON recordset when the desired zipcode is not found.

The left side of FIG. 5 illustrates indexing structure 502 as it may be when saved in storage within the CryptoJSON recordset system. The saved version of indexing structure 502 may include encrypted versions of all plaintext references, for example, ciphertext-1 of the first item of node 502 and ciphertext-2 of the second item of node 502. That is, all plaintext references, including the index values, may be saved in encrypted form while the organization of the indexing structure remains unchanged. In other words, an order of items in index nodes and the linkages between nodes may be arranged according to the plaintext index values although all plaintext references, including the index values, may be saved in encrypted form. Further, any other information related to a plaintext item that may be used by the index, such as, for example, plaintext statistics, may also be encrypted. The plaintext references used by the indexing structure, including the information related to a plaintext item, may be encrypted in the saved indexing structure by using the same key that was used to encrypt the corresponding data in the CryptoJSON recordset or by another key.

FIG. 5 illustrates an exemplary node of an indexing structure having two items. In other embodiments, more or fewer items may be stored within a node of the indexing structure.

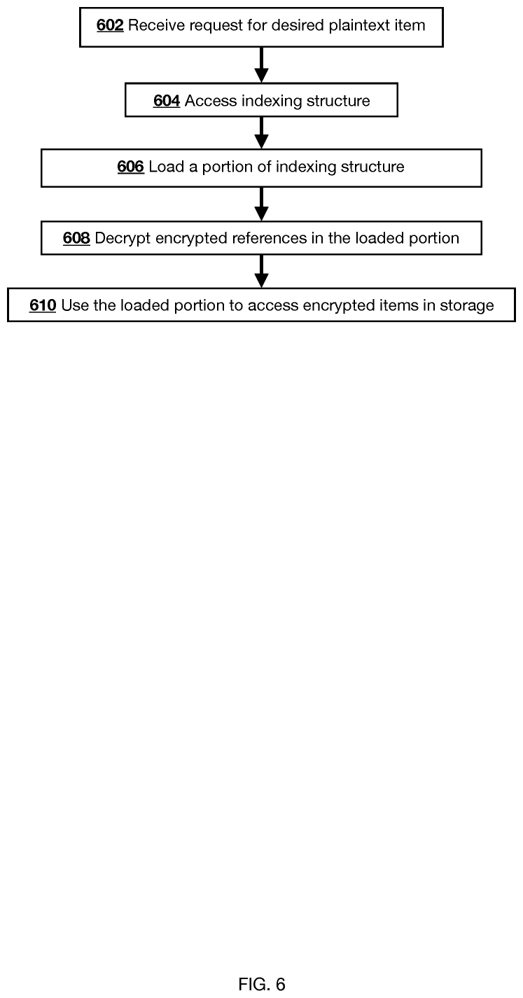

FIG. 6 is a flowchart that illustrates an exemplary process for using an indexing structure, such as, for example, the exemplary indexing structure of FIG. 5, to search for non-deterministically encrypted data in a CryptoJSON recordset in embodiments consistent with the subject matter of this disclosure. First, processing device 102 may receive a request for a desired data item that may be included in a CryptoJSON recordset of processing device 102 (act 602). The request may be made directly by a requester such as, for example, a user or an application, via processing device 102 or via another processing device, such as processing device 104 via a network, such as network 106. The request may be a search request and may include a plaintext form of the desired data item. Next, processing device 102 may access an indexing structure of the CryptoJSON recordset in order to perform a search for data in the CryptoJSON recordset that corresponds to the desired data item (act 604). Processing device 102 may then load at least a portion of the indexing structure into dynamic storage, such as memory 230 (act 606). Processing device 102 may then decrypt encrypted references in the loaded portion of the indexing structure (act 608) and may use the loaded portion of the indexing structure to find and access one or more non-deterministically encrypted data items in the CryptoJSON recordset (act 610).

In one embodiment, processing device 102 may decrypt the encrypted references of the indexing structure as an index page or portion of the indexing structure is loaded into memory 230. In such an embodiment, searching may then be performed using the corresponding plaintext references and other information from the indexing structure. In another embodiment, the plaintext references from the indexing structure may be decrypted as the search is performed, such as, for example, when a plaintext reference from the index is needed.

The exemplary method described above, with reference to FIG. 6, may be used to search for data pertaining to a particular data item, such as, for example, an equality search, may be used to search for data pertaining to a range of data values, such as, for example, a range search, or may be used to perform a search for information that is similar to a particular data item, such as, for example, a fuzzy search.

1. A method for performing a search on non-deterministically encrypted data in a CryptoJSON recordset system, the method comprising:
determining, transparently to a user, an indexing value for a desired plaintext item of data provided by the user, the indexing value being based, at least partially on the desired plaintext item of data and a transformation expression;
using the indexing value to access a corresponding entry in an indexing structure to obtain a CryptoJSON recordset entry including non-deterministically encrypted ciphertext corresponding to the desired plaintext item of data.

2. The method of claim 1, wherein the determining of the indexing value for a desired plaintext item of data further comprises:
calculating a code based on applying the transformation expression to the desired plaintext item of data.

3. The method of claim 1, wherein the indexing structure includes at least a first item of each of a plurality of paired data items, the first item of each of the plurality of paired data items being an indexing data item having a value based on a respective plaintext data item and the transformation expression and a second item of each of the paired data items being the transformation expression corresponding to what may be applied to the respective plaintext data item to obtain the indexing value.

4. A method for providing a remote CryptoJSON recordset for performing a search on non-deterministically encrypted data in a CryptoJSON recordset system, the method comprising:
receiving a remote request from a requester, via a network, to search the non-deterministically encrypted data in the CryptoJSON recordset system for a CryptoJSON recordset entry corresponding to a desired plaintext data item;
calculating, transparently to the requester, a code based on the desired plaintext data item and a transformation expression;
using the code as an index to an indexing structure to obtain the CryptoJSON recordset entry corresponding to the desired plaintext data item; and
returning data to the requester, the returned data including the CryptoJSON recordset entry corresponding to the desired plaintext data item obtained from the CryptoJSON recordset system.

5. The method of claim 4, wherein the indexing structure comprises a plurality of items, each of the plurality of items including at least a first item of a duplet and a second item of the duplet, the first item of the duplet comprises a code based on a corresponding plaintext data item and the transformation expression, the second item of the duplet comprises the transformation expression corresponding to what may be applied to the respective plaintext data item to obtain the indexing value.

6. The method of claim 4, wherein the indexing structure comprises a plurality of items, each of the plurality of items including at least a first item of a duplet and a reference to a second item of the duplet, the first item of the duplet comprises a code based on a corresponding plaintext data item and the transformation expression, the reference to the second item of the duplet includes a pointer to a data structure including the second item of the duplet, and the second item of the duplet comprises the transformation expression corresponding to what may be applied to the respective plaintext data item to obtain the indexing value.

7. The method of claim 4, wherein the indexing structure includes a B-tree.

8. A machine-readable medium having instructions stored therein for at least one processor, the machine-readable medium comprising:
instructions for accessing an indexing structure for a CryptoJSON recordset, a position of items in the indexing structure being based on corresponding plaintext items, references related to the corresponding plaintext items in the indexing structure being encrypted and other information in the indexing structure being unencrypted;
instructions for loading at least a portion of the indexing structure into a memory;
instructions for decrypting at least one of the references related to a corresponding one of the plaintext items in the at least a portion of the indexing structure; and
instructions for using the decrypted at least one of the references to access a corresponding non-deterministically encrypted data item from the CryptoJSON recordset.

9. The machine-readable medium of claim 8, wherein:
the instructions for decrypting at least one of the references related to the corresponding plaintext item in the at least a portion of the indexing structure are executed when a page of the indexing structure is loaded into the memory.

10. The machine-readable memory of claim 8, wherein:
the instructions for decrypting at least one of the references related to the corresponding plaintext item in the at least a portion of the indexing structure are executed when the at least a portion of the indexing structure is used to search for non-deterministically encrypted data in the CryptoJSON recordset corresponding to a desired data item.

11. The machine-readable medium of claim 8, wherein the encrypted references related to the corresponding plaintext item include plaintext statistics.

12. The machine-readable medium of claim 8, wherein the indexing structure includes a B-tree.
